(19) United States
(12) Patent Application Publication
(10) Pub. No.: US 2004/0183059 A1
(43) Pub. Date: Sep. 23, 2004

(54) Method and apparatus for an improved lifting system

(76) Inventor: Shannon O'Rourke, Darlington (AU)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/481,008

(22) PCT Filed: Jun. 12, 2002
(86) PCT No.: PCT/AU02/00758

(30) Foreign Application Priority Data
Jun. 12, 2001 (AU) PR 5640

(51) Int. Cl. B66D 1/50

(52) U.S. Cl. 254/275

(57) ABSTRACT

A single person hoist for use in a derrick (2), including a motive device (4), a suspension cable connected to said motive device, and from which the person is suspended by suspension means (4) and a control means for operating the motive device, wherein the control means is operable by the person whilst suspended from the suspension means.

### FIELD OF THE INVENTION

The invention relates to the mining industry and, in particular, the petroleum industry whereby a means of extracting oil and gas is achieved through a drilling assembly supported above ground by a derrick. In particular, the invention relates to the means by which a derrick undergoes maintenance and the access provided for maintenance personnel to various positions within said derrick.

### BACKGROUND OF THE INVENTION

In both onshore and offshore oil and gas drilling, a derrick, typically around 200 ft in overall height, is constructed to house drilling equipment. A derrick Is typically constructed from a framework of steel members so as to support the dead weight of the drilling equipment held in a vertical orientation as well as to provide a means of transferring any reaction force due to the drilling back Into the ground. As a result, a derrick resembles a network of members having a series of free zones, each zone being separated by drilling equipment. It follows, therefore, that a derrick, in order to perform its primary function, cannot provide for an uninterrupted access shaft other than to accommodate the drilling equipment.

It is the nature of oil and gas drilling that structures such as derricks and equipment used for drilling must undergo frequent and extensive maintenance so as to maintain the Integrity of what are critical and expensive pieces of infrastructure. It is therefore necessary for maintenance personnel to inspect and repair various portions of the derrick and contained equipment so as to ensure a continuous drilling operation. It is therefore necessary for maintenance personnel to have complete access to all points internally and externally of the derrick. Given the considerable height of a derrick, it is typical for such maintenance personnel to use safety equipment supported by a lifting means, so as to move vertically within the derrick.

The cluttered arrangement of steel members and equipment within a derrick cannot accommodate sufficient clearance to permit the use of a lifting cage or elevator, as would be the case with more conventional structures. It is therefore the practice within the industry for maintenance personnel to be suspended via a harness attached to a cable being lifted by some type of motive apparatus, for instance as a winch. The advantage of this arrangement over an elevator or cage system is that the person being lifted or lowered is able to navigate around the steel framework traversing from one free zone to the next. Thus, it is necessary for the maintenance person to have free lateral movement whilst being lowered or lifted to the desired location.

The complete system of the prior art involves a winch being operated by an operator on the ground that maintains, whenever possible, visual and radio contact with the maintenance person. It follows that the maintenance person can indicate the zone to which he wishes to be transferred for inspection or maintenance and is correspondingly lifted or lowered by the winch operator. In certain circumstances, a third person may be used to maintain visual contact with the maintenance person and, thus, assist in maintaining visual contact and communication with the maintenance person.

Whilst a common arrangement for maintaining a derrick, this is, nevertheless, an extremely hazardous system and one that has led to many accidents, including fatalities. It follows that any breakdown in communication between the maintenance personnel and either, or both, of the winch operator and his assistant can lead to the maintenance person being lifted or lowered at a rate that is too rapid to successfully negotiate the steel framework of the derrick. The maintenance person, being in communication with the winch operator, will indicate to the operator that he wishes, for instances, the lifting process to be suspended just prior to the maintenance person wishing to traverse an obstacle in the framework. Any breakdown in communication, either by a misunderstanding by the winch operator, or a failure of the radio communication system, will mean that only visual observation by the operator and his assistant will prevent the occurrence of an accident. Because of the complexity of the steel framework, it is common for the maintenance person to be partially, or completely, obscured from both the operator and his assistant.

It would be advantageous if the risk associated with a communication breakdown could be minimised and, thus, reduce the accident rate of the aforementioned maintenance activity.

### SUMMARY OF THE INVENTION

It is therefore an object of the invention to reduce the dependence on communication for the movement of a maintenance person and the risk such a person faces should there be such a breakdown.

Therefore, in one aspect of the invention there is provided a single person hoist for use in a derrick, including a motive device, a suspension cable connected to said motive device, and from which the person is suspended by suspension means, and a control means for operating: the motive device wherein the control device is adapted for use by the person whilst suspended from the cable.

Therefore the invention provides a means by which a ground based operator, with or without an assistant, becomes redundant and direct control of the lifting and lowering of the maintenance person is placed in the hands of that person.

The motive device operating the cable may be a simple cable drum winch, whereupon cable is drawn or reeled out at a rate determined by the rotation of the drum, which is subsequently controlled by the control device.

The suspension means may be a simple loop and harness arrangement, whereby the cable may include a means to attach to a harness worn by the person. Alternatively, the suspension means may provide for a seating arrangement for the person, again connected to the cable either releasably or otherwise. In any event, whatever form the suspension means may take, it is central to the invention that it not hinder the movement of the person through the steel framework. An arrangement where an elevator or cage may be incorporated must provide for free access of said object through the framework and, thus, is inappropriate to this application. In any event, the severity of accident that may occur should a cage or elevator be used in place of an unprotected person is substantially diminished and, thus, is associated with a different arrangement and circumstance.

The control means may include a simple pendant control having a cable in parallel with the suspension cable and, thus, providing a direct electrical connection to the winch. Whilst remote control devices exist, these are inappropriate for this application as it has been established that a core problem with the prior art is the lack of reliable sight lines between the person and the winch. Thus, any remote control device requiring direct line of sight to maintain control will, in itself, present a hazard. Similarly, a remote control device relying on, for instance, radio waves, will, again, lack the required level of safety as a radio may be intermittently affected by the quantity of steel in the structure and, thus, provide a source of interference. In any event, a remote control relying on radio waves may not be appropriate because of the volatile environment and the need to handle explosives. In general, remote communication devices are generally prohibited for use near petroleum products, whether it be for drilling, refining or dispensing. The prohibition of mobile phones in these environments being an example.

In an alternative arrangement, the suspension cable may be a multi-conductor lifting cable, whereby said multi-conductor lifting cable provides a communication signal between the pendant control and the motive device.

The control means may further include an emergency shut-off device, possibly an emergency stop button located on the pendant control. The control means may also include an emergency shut-off device at the motive device, such that a second person may bring the single person hoist to a halt. This is particularly advantageous when the maintenance person is unaware of an impending hazard or, for one reason or another, is unable to activate the pendant located emergency shut-off device. Such a situation may be caused by an injury suffered by the maintenance person or damage to the pendant control and so provide for further redundant safety systems incorporated within this preferred embodiment of the present invention.

In the case of the emergency shut-off device being used only in an emergency, in another preferred embodiment, the emergency shut-off device may be in communication with a warning device such as an alarm bell and/or flashing light such that said warning device is activated when the emergency shut-off device is activated. Said warning device may be located at the motive device and in proximity to the operator so as to maintain communication between the operator and a remote station such as the motive device.

It follows that in various preferred embodiments of the present invention having additional personnel at remote locations either at the motive device or at a more convenient point of observation may be advantageous. Thus, in a preferred embodiment of the present invention, there may also be personnel located at said remote locations In an observation and emergency reaction role. This is distinct from the previous conventional systems whereby said personnel in remote locations had primary control, in this embodiment of the present invention said personnel are merely used in support and provide further redundancies to the overall safety of the system defined by the present in invention. Thus, In this embodiment, communication between the operator and the remote personnel may be advantageous and may be facilitated through an intercom communication system operating through the multi-conductor lifting cable.

In a more preferred embodiment, whereby the present invention makes use of personnel located at the winch device, the control system may further include a “push and hold to operate” button. Said button may operate such that the person positioned at the motive device must press and hold the button so as to operate the hoist. Should the person release the button, the hoist would then come to a halt. This ensures that the operator is always supported by a second person.

In a further preferred embodiment, the control means may further include acceleration and/or deceleration control means. Given the size of a derrick for which the present invention is applicable, it may be necessary for an operator to travel a considerable distance between two points. To avoid significant travel time, a motive device may be selected to lift or lower the operator as quickly as possible between said points. To avoid injury or undue discomfort to the operator, the control means may further include acceleration or deceleration means such that on activation of the motive device, the operator undergoes a controlled acceleration, which is limited to an acceleration rate so as to prevent injury or discomfort. Similarly, the deceleration control means will control the deceleration of the operator from the optimum travel speed to complete a stop. Said acceleration and/or deceleration means may be provide as an operator controlled acceleration/deceleration means similar to an accelerator in a motor vehicle. Alternatively, said acceleration and/or deceleration means may be provided through a range of speed settings controlled by the operator giving the operator control of the speed of the motive device and consequently acceleration and deceleration. In a further alternative embodiment, the acceleration and/or deceleration control means may be algorithms within a control device such that on activation of the motive device, the control means automatically regulates acceleration and similarly at stop the control means may automatically control deceleration. It follows that there will be issues with timing of stopping and the distance through which the deceleration control means may decelerate the operator. Said issues are solved by known devices and techniques such as an experienced operator's judgement, limit switches, proximity devices, and the like. It will be clear to the person skilled in the art that use of such a deceleration control means with known safety measures will fall within the scope of this embodiment of the present invention.

As a further redundancy measure for the safety of the operator, a flashing beacon may be Included at either a remote location, such as the motive device or an observation point, or at a clearly visible point on the derrick such that said flashing beacon is activated when an operator is using the hoist of the present invention.

In a second aspect of the invention, there is provided a control device for operating a motive device of a single person hoist, said hoist further including a suspension cable connected to said motive device and from which the person is suspended by suspension means wherein the control device is adapted for use by the person whilst suspended from the cable.

In a third aspect of the invention, there is provided a method for moving a person from a first zone in a derrick to a second zone, including the steps of suspending said person from a cable connected to a motive device and operating said motive device so as to move the person from the first to second zone wherein operation of the motive device is effected by a control device used by the person.

Thus, in a preferred embodiment of the invention, there may be provided an arrangement comprising a winch, a suspension cable connected to the winch via a slip ring assembly at one end of the cable, and the other end of the cable may be connected to a person suspended via a harness. Control of the position of the person may be effected by controlling the winch with the controls being via a pendant control connected to the suspension cable and so the person may control his vertical movement by directly controlling the winch and lateral movement by manually traversing the steel framework within the derrick.

### DESCRIPTION OF PREFERRED EMBODIMENT

It will be convenient to further describe the present invention with respect to the accompanying drawings, which illustrate a possible arrangement of the invention. Other arrangements of the invention are possible and, consequently, the particularity of the accompanying drawings Is not to be understood as superseding the generality of the preceding description of the invention.

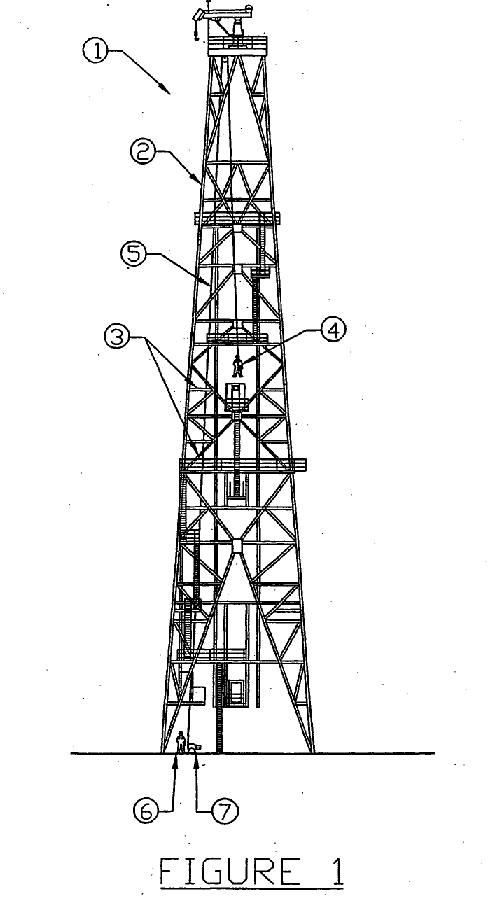

FIG. 1 is an elevation view of a single person hoist according to the present invention;

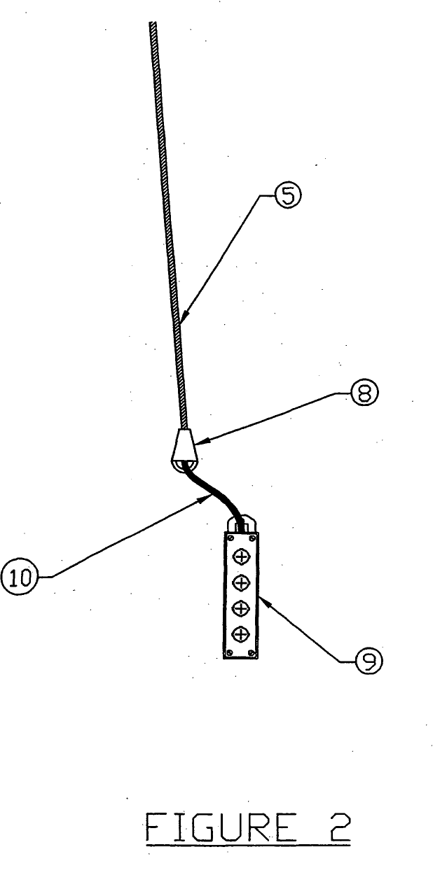

FIG. 2 is a detailed view of the control device according to one aspect of the present invention of FIG. 1.

FIG. 1 shows the hoist arrangement 1 of the present invention as it applies to the suspension of a maintenance person 4 within an oil drilling derrick 2. Arrangements of the prior art involve a maintenance person 4 being suspended from a cable 5 whereupon movement of the maintenance person 4 in a vertical direction is effected by the operation of a winch 7. The maintenance person 4 maintains communication with a winch operator 6 whereupon the maintenance person 4 determines when, and at what rate, he is to be moved vertically so as to move within the steel framework 3 of the derrick 2. Because of the complexity of the steel framework 3, it is impractical to have a shaft in which a shaft or elevator may be used to effect the vertical movement. Thus, a hoist arrangement 1 attached to the maintenance person 4 provides for the vertical movement and lateral movement of the person 4 is achieved by the maintenance person 4 manually traversing the steel framework 3 from point to point.

Because of the complexity of the steelwork 3 and contained equipment (not shown), visual contact between the winch operator 6 and the maintenance person 4 is often, and In fact usually, obscured and so communication is confined to a radio link between the two persons 4 and 6.

Through one or a combination of factors, such as the hostile environment, the volume and complexity of steelwork 3, and simple human error, the arrangement of the prior art introduces a level of risk in that any disruption to the communication link can lead to a serious, and potentially, fatal accident.

The typical load-bearing capacity of the cable 5 and the winch 7 is approximately 5 tonnes. Clearly, if, through a miscommunication, a maintenance person 4 becomes entangled with, or wedged between, the steel framework 3, the winch and cable are easily capable of causing severe injury to the person 4. This has, in fact, been documented on a number of occasions. Nevertheless, up until the present invention, no suitable, or practical, method has been found and adopted to avoid this unnecessary risk.

FIG. 2 shows the loop 8 at the end of the suspension cable 5 onto which the maintenance person 4 will attach his harness. Projecting from the cable providing easy and convenient access to the maintenance person 4 is a control pendant 9 in direct communication with the winch 7. When the maintenance person 4 is engaged with the cable 5, said person 4 is able to directly control the winch 7 so as to lower and raise himself as desired. Clearly, this negates the need for the winch operator 6 and, more importantly, avoiding the vertical movement of the person 4 through communication, which is liable to disruption.

The pendant control is in direct connection with the winch through cable 10, which is connected to, and running in parallel with, the cable 5. Whilst a remote control (not shown) may be advantageous in some applications, in general application of the present invention, whereby use of the hoist arrangement 1 is in an oil or gas rich environment, the use of such a remote communication device is undesirable. In any event, the complexity of the steel framework 3, contributing both to electrical interference and a lack of direct line of sight with the winch, makes a remote control impractical in most situation.

The claims defining the invention are as follows:

1. A single person hoist for use in a derrick, including a motive device, a suspension cable connected to said motive device, and from which the person is suspended by suspension means and a control means for operating the motive device, wherein the control means is operable by the person whilst suspended from the suspension means.

2. The single person hoist according to claim 1, wherein the control means includes a control input device in communication with the motive device, using communication means.

3. A single person hoist according to claim 2, wherein the communication means is a direct electrical connection.

4. The single person hoist according to any one of the preceding claims, wherein the motive device includes a cable drum winch and the suspension means includes a cable drawn in or reeled out from the cable drum winch.

5. The single person hoist according to claim 4 or 5, wherein the cable is a multi conductor lifting cable, further Including the communication means.

6. The single person hoist according to any one of the preceding claims, wherein the suspension means further includes a loop and harness at an operator end adapted to fit the person.

7. The single person hoist according to any one of claims 1 to 5, wherein the suspension means further includes a seating arrangement at an operator end.

8. The single person hoist according to any one of claims 2 to 7, wherein the control input device includes a pendant control adjacent the operator end, said pendant control providing means to permit the person to control the ascent and descent of the hoist.

9. The single person hoist according to any one of the preceding claims, wherein the control means further includes an emergency shut off device.

10. The single person hoist according to claim 9 wherein the emergency shut off device includes an emergency stop button located on the pendant control.

11. The single person hoist according to claim 9 or 10, wherein the emergency shut off device further includes an emergency stop button located adjacent the motive device.

12. The single person hoist according to claims 9 to 11, wherein the emergency shut off device includes a warning device, which is activated on activation of the emergency shut off device.

13. The single person hoist according to claim 12, wherein the warning device includes an alarm bell and/or a flashing light.

14. The single person hoist according to any one of claims 3 to 13, wherein the communication means includes means for providing an intercom communication system between the operator end of the suspension means and the motive device.

15. The single person hoist according to any one of the preceding claims, wherein the control means further includes acceleration control means for controlling the acceleration of the person from a stationary position to a predetermined lifting or lowering speed.

16. The single person hoist according to claim 15, wherein the acceleration control means includes a manually operable accelerator on the pendant control.

17. The single person hoist according to claim 15, wherein the acceleration control means includes discrete speed setting means located on the pendant control such that the operator may select from a range of discrete speed settings.

18. The single person hoist according to claim 17, wherein the speed setting means includes a plurality of buttons on the pendant control, whereby activation of any one button will lead to an acceleration or deceleration from a current speed to a speed corresponding to said button.

19. The single person hoist according to claim 15, wherein the acceleration control means includes an algorithm within a control system in communication with the control means such that on activation of the motive device, the algorithm regulates the acceleration of the hoist.

20. The single person hoist according to any one of the preceding claims, further including a flashing beacon automatically operable on activation of the motive device.

21. The single person hoist according to claim 20, wherein the flashing beacon is located at a point clearly observable from the ground.

22. A control device for operating a motive device of a single person hoist according to any one of the preceding claims.

23. A method for moving a person from a first zone in a derrick to a second zone, including the steps of suspending said person from a cable connected to a motive device and operating said motive device so as to move the person from the first to the second zone, wherein operation of the motive device is effected by a control means operable by the person.
